(19) United States
(12) Patent Application Publication
(10) Pub. No.: US 2022/0067619 A1
(43) Pub. Date: Mar. 3, 2022

(54) SYSTEM AND METHOD TO PROVIDE PRESCRIPTIVE ACTIONS FOR WINNING A SALES OPPORTUNITY USING DEEP REINFORCEMENT LEARNING

(71) Applicant: Clari Inc., Sunnyvale, CA (US)

(72) Inventor: Balasubramaniam RAJU, Palo Alto, CA (US)

(21) Appl. No.: 17/007,713

(22) Filed: Aug. 31, 2020

(51) Int. Cl. G06Q 10/06; G06N 3/04; G06Q 10/10; G06K 9/62

(52) U.S. Cl. CPC G06Q 10/06316; G06K 9/6262; G06Q 10/103; G06N 3/04

(57) ABSTRACT

The disclosure describes a method of training a prescriptive artificial intelligence agent to prescribe a next action for a sales opportunity. The method includes receiving a simulated task, and its attributes and associated actions at a training platform, which include the prescriptive agent to be trained and an environment. The method further includes receiving, at the environment, action information recommended by the prescriptive agent, the action information including a particular type of action and a state of the simulated task. The method further includes generating, by the environment, an indicator indicating whether the simulated task is associated with the type of action at the state of the simulated task, and determining a change in the state of the simulated task, the state change being a change in one or more attributes of the simulated task. The method further includes calculating a reward based on the generated indicator and the changed state, and sending the reward and the change state to the prescriptive agent.

### TECHNICAL FIELD

Embodiments of the present invention relate generally to machine learning. More particularly, embodiments of the invention relate to training a prescriptive agent to suggest actions to win a sales opportunity.

### BACKGROUND

Machine learning has been used for sales forecasting over the years. Various machine learning models have been trained using labeled past sales data to envision future sales revenues, allocate human and monetary resources according to forecasts, and prepare strategies future growth. Examples of these machine learning models include Linear Regression, Random Forecast Regression, XGBoost, and Long Short-Term Memory (LSTM) model.

However, there is no existing automated industry solution that can prescribe next steps for sales personnel to take in order to move a sales opportunity forwards to a successful closing. Each salesperson needs to learn on the job over many years to figure out what the winning formula is, and what action to take given a particular stage of a sales opportunity.

### BRIEF DESCRIPTION OF THE DRAWINGS

Embodiments of the invention are illustrated by way of example and not limited to the figures of the accompanying drawings in which like references indicate similar elements.

FIG. 1 illustrates a system for training an AI agent for prescribing actions for a given sales opportunity according to one embodiment.

FIG. 2 further illustrates the system for training an AI agent for prescribing actions for a given sales opportunity according to one embodiment.

FIG. 3 further illustrates the system for training an AI agent for prescribing actions for a given sales opportunity according to one embodiment.

FIGS. 4A-4B illustrate a graphic user interface where a user can see the suggested actions generated by a trained AI prescriptive agent according to one embodiment.

FIG. 5 illustrates a process of training a prescriptive agent to prescribe actions for a task according to one embodiment.

FIG. 6 illustrates a process of prescribing a next action for a sales opportunity using a prescriptive agent.

FIG. 7 is a block diagram illustrating an example of a data processing system which may be used with one or more embodiments of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” or “in an embodiment” in various places in the specification do not necessarily all refer to the same embodiment.

The disclosure discloses systems and methods for training artificial intelligence (AI) agent using Deep Reinforcement Learning (DRL) to learn the maneuvers of a successful sales person. The trained AI agent can then be deployed to prescribe actions that need to be taken by a salesperson to move a sales opportunity forward towards closing.

According to an exemplary method of training a prescriptive agent, a training platform can receive a simulated task and its attributes and associated actions from databases, and provide the simulated task and its associated data to an environment in the training platform. The environment receives action information recommended by a prescriptive agent, the action information including a particular type of action and a state of the simulated task. The environment generates an indicator indicating whether the simulated task is associated with the type of action at the state of the simulated task, and determines a change in the state of the simulated task, the state change being a change in one or more attributes of the simulated task. The environment then calculates a reward based on the generated indicator and the changed state of the simulated task, and sends the reward and the changed state to the prescriptive agent.

In one embodiment, the life cycle of a simulated task includes a number of stages. The above operations can be repeated for each stage of the simulated task at least once except the terminal stage, during which the simulated task is either closed or abandoned. A state of a simulated task can change when the simulated task transits from one stage to another or, when one or more other attributes of the simulated task change, for example, a client contact is added or removed.

The environment can include multiple simulated tasks, and their attributes and associated actions. The above operations can be repeated for each simulated task.

In one embodiment, the attributes of the simulated task include a stage of the simulated task, their associated source contacts and target contacts, and the duration of each stage.

In one embodiment, the prescriptive agent is a deep neural network, which takes a given state of one of the simulated task as an input, and outputs a Q score for each of a number of actions to be taken for the given state. The Q score for each action represents an expected total future reward for taking the action for the simulated task at the given state.

In one embodiment, the state of a simulated task can be defined by the attributes of the simulated task. Therefore, a state change in the simulated task can refer to a transition from one stage to another stage, or a change in one or more other attributes of the simulate task.

In one embodiment, the prescriptive agent can include a policy function that selects an action associated with a highest Q score form the multiple Q scores, and sends the selected action and the state of the simulated task to the environment. A reward can be generated by the environment based on the selected action and the attributes of the simulated task. The reward is the ground truth value for the selected action, while the Q score associated with the selected action is the expected value. A loss function in the prescriptive agent can use the expected Q score and the ground truth value to train the prescriptive agent.

In one embodiment, the actions include a variety of activities conducted by a salesperson with an outside party in closing a sales opportunity, including email messages, phone conversations, meetings, document sharing, demos, proofs of concept (POCs), business validations, technical validations, and contract negotiations. The actions can also include a number of features derived from the above-listed actions; the derived features can include a frequency of one of the plurality of actions, a sentiment score, and a timing of an action.

In one embodiment, the trained prescriptive agent can be deployed in a cloud server for use by a salesperson. When the salesperson logs into to her account, a list of sales opportunities (tasks) assigned to her can be displayed, and each task may have different attributes. The salesperson may select one of the tasks, and the selection can trigger the trained prescriptive agent, which can generate a recommended action based on the current state of the selected task, and display the recommended action to the salesperson.

The above summary does not include an exhaustive list of all embodiments in this disclosure. All methods described above can be practiced from all suitable combinations of the various aspects and embodiments described in the disclosure.

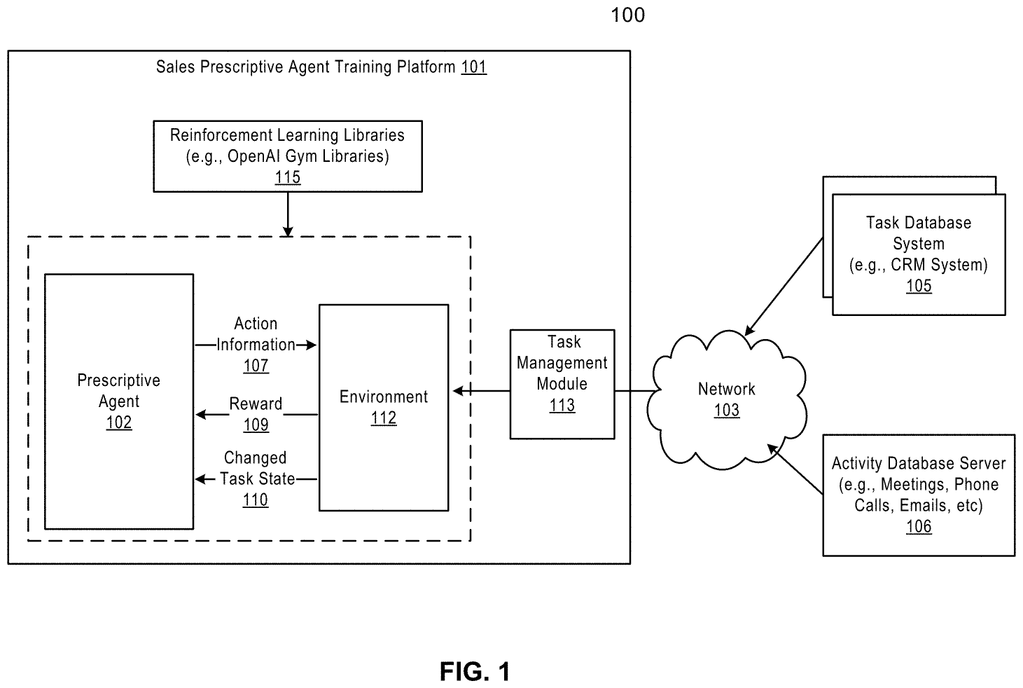

FIG. 1 illustrates a system 100 for training an AI agent for prescribing actions for a given sales opportunity according to one embodiment. The system 100 includes a sales prescriptive agent training platform 101, which can include a set of Reinforcement Learning (RL) libraries 115. The RL libraries can be provided by open source RL training frameworks, such as OpenAI Gym. The RL libraries can be installed in any computing platform, such as Windows X server, macOS, or Linux. The sales prescriptive agent training platform 101 further include a prescriptive agent 102, an environment 112, and a task management module 113.

In one embodiment, the prescriptive agent 102 can be an algorithm to be trained using Deep Reinforcement methodology. It can be implemented with a neural network (e.g., a deep neural network (DNN)) or Q-table. The prescriptive agent 102 is the entity to be trained using a Deep Reinforcement Learning methodology.

In one embodiment, the environment 112 can be a software module that represents simulated tasks and their associated attributes. The simulated tasks can be completed tasks stored in a task database system 105, such a customer relationship management (CRM) system in a past period. Each simulated task can be a sales opportunity or a project, and has attributes, such as one or more stages that the task has been through, contact information for sales personnel and client parties. A simulated can be lost at any stage. For example, a project can be abandoned as a lost sales opportunity as soon as it is opened because the potential client had closed its business. A won deal, however, needs to go through a number of predetermined stages, including “new”, “pipeline”, “commit”, and “closed”. The stages constitute a life cycle of a won deal as defined by a system administrator.

Each task can also be associated with interactions between the sales personnel and client parties at each stage of the task. Each task is associated with a source contact and one more target/client contacts. To move a task from one stage to another, a salesperson typically needs to interact with one or more target contacts to take actions. The interactions can include actions such as emails, phone conversations, meetings, document sharing, demos, proofs of concepts (POCs), business/technical validations, and contract negotiations; and derived features from the actions. The interactions can be stored in an activity database server 106.

In one embodiment, the task management module 113 is configured to communicate and interact with the task database system 105 to obtain tasks and their associated attributes. The task management module 113 is also configured to communicate and interact with the activity database server 106 to retrieve interactions associated with the tasks from the task database system 105. When communicating with the task database system 105, the task management module 113 can use one of a variety of APIs or protocols compatible with task database system 105. Similarly, when communicating with the activity database system 106, the task management module 106 can also use one of a variety of APIs or protocols compatible with the activity database system 106. The task management module can retrieve, stage, and/clean the task information retrieved from the task database system 105 and interaction information from the activity database system 106, and match the interactions to each stage of a task.

During the training process, at each step, the prescriptive agent 102 can execute a simulated action indicated by action information 107, observes a change 110 in a stage of a project due to the simulated action, and receives a reward 109. The simulated interaction action can be any of the interactions described above, for example, a phone conversation or an email message. The project state change 110 can be a stage transition of a simulated task, for example, a transition from a “New” to “Pipeline”. The reward 109 can be a Boolean value reflecting a positive or negative impact the simulated action had on the simulated task.

Once the prescriptive agent 102 is trained, it can be deployed to prescribe the next action to take for a given task. The prescriptive action can be stored in a database. When a salesperson accesses that opportunity, the prescriptive action can be displayed via a graphic user interface to the salesperson.

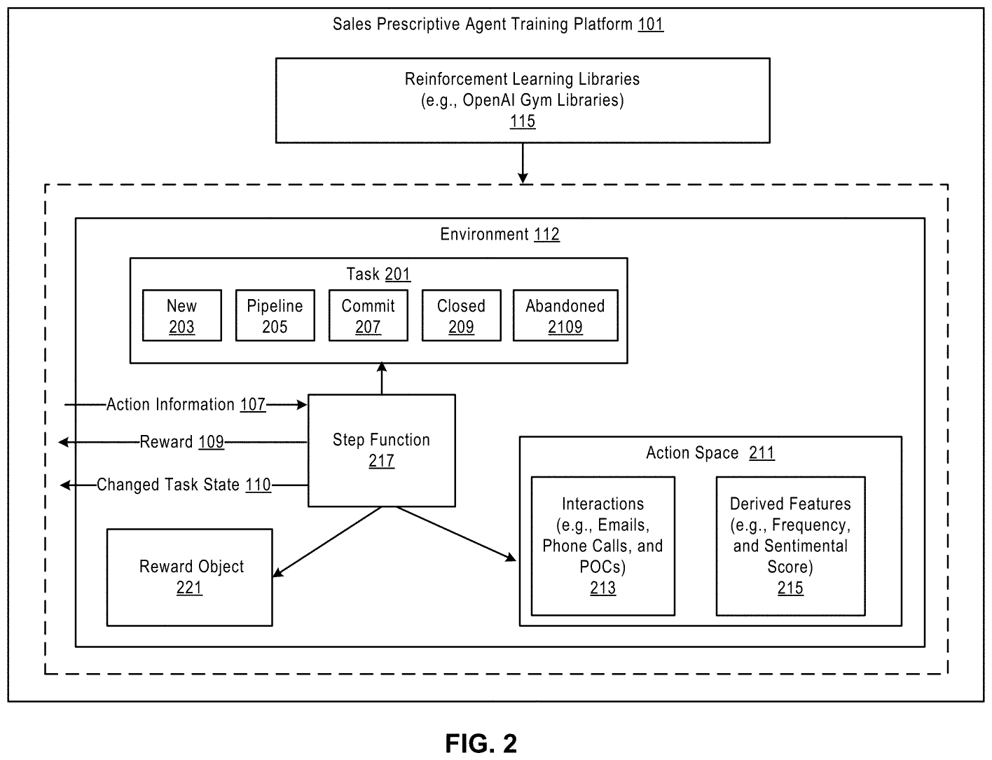

FIG. 2 further illustrates the system 100 for training an AI agent for prescribing actions for a given sales opportunity according to one embodiment.

More specifically, FIG. 2 illustrates additional details of the environment 112. The environment 112 can be implemented as a software module that includes a state object 201, reward object 221, and action space 221 object. The environment 112 further includes a step function 217 used to communicate with the prescriptive agent 102. During the training process of the prescriptive agent 102, the prescriptive agent 102 can call the step function 217, and provide an action (e.g., action indicated by action information 107) in the argument of the function call. The step function 217 can return a changed task state (e.g., changed task state 110) and a reward (e.g., reward 109) to the prescriptive agent 102.

In one embodiment, the environment 102 can also return a variable indicates whether an episode has terminated or not. As used herein, an episode is one of multiple repeated attempts by the prescriptive agent 102 to learn the environment 112. In this disclosure, an episode the length of the simulation at end of which the system ends in a terminal state. For example, the prescriptive agent 102 completes an episode once a simulated task moves from n initial state (e.g., “New) to a terminate state “Closed” or “Abandoned”).

In one embodiment, the state object 201 can include a number of fields represents all possible stages that a task can have. These stages are defined by a system administrator based on the nature of a business or products to be marketed. In the embodiment illustrated in FIG. 2, the task object can include the fields for a “New” stage 203, a “Pipeline” stage 205, a “Commit” stage 209, a “Closed” stage 209, and a “Abandoned” stage 210. These stages represent states for a simulated task.

In one embodiment, the action space object 211 include a number of fields representing various actions 213 and features 215 derived from the actions. As described above, the interactions can be actions taken by a salesperson to advance a simulate task, and can include such activities as emails, phone calls and meetings. The derived features 215 can include frequency of a particular interaction (e.g., number of meetings), a sentiment score, and a timing of interaction. Although the prescriptive agent 102 cannot directly perform a derived feature as an action to impact a simulated task, an interaction in combination with a value of a derived feature may have a different impact on a simulated task than the interaction in combination with a different value of the derived feature.

For example, a phone conversation followed a demo may have a different impact on a task than a phone conversation before a demo. As another example, a phone conversation followed by another phone conversation may have a different impact on a task than a phone conversation alone, as the frequency of the same interaction may have indicated whether the client party prefers this type of communications.

In one embodiment, the reward object may define a reward system. The reward system can include a function to calculate a score to indicate how good a particular action is in terms of advancing a simulated task form one stage to a next stage.

For example, the function may define that an action gets 1 point if the simulated task changes to a next stage in the life cycle of a completed task as long as the next stage is not “Abandoned”. If the next stage is “Abandoned”, the action gets −1 point. If the simulated task is not associated with an action, the action will get 0 point. The above implementation is provided as an example, Other algorithms for calculating reward points or other types of rewards can be used.

In one embodiment, the step function 217 can include an infinitive loop for each episode of training. The number of iterations for the loop is equal to the number of stages in the simulated tasks corresponding to the episode.

In the beginning of each episode, the prescriptive agent 102 can send a random action (e.g., a phone conversation) as indicated by the action information 107. The action information 107 can include a type of action and a particular stage of a simulated task for which the action is to be performed. When receiving the interaction action 107, the step function 217 can call the task object 201 that is initialized with the different states of the simulated task and actions for each stage.

The task object 201 then can call the reward object 221 to calculate a reward based on the action information 107. In one embodiment, if the type of action indicated by the action information 107 was not performed for the simulated task based on the data loaded form the task database system 104, the reward for the type of action would be 0 point. If the action was performed and the next stage of the simulated task is “Abandoned”, the reward would be −1 point. If the action was performed and the next stage of the simulated task is not “Abandoned”, the reward would be 1 point.

The step function 217 can send the reward and the next stage of the simulated task to the prescriptive agent for use by the prescriptive agent to select a next action for the environment 112.

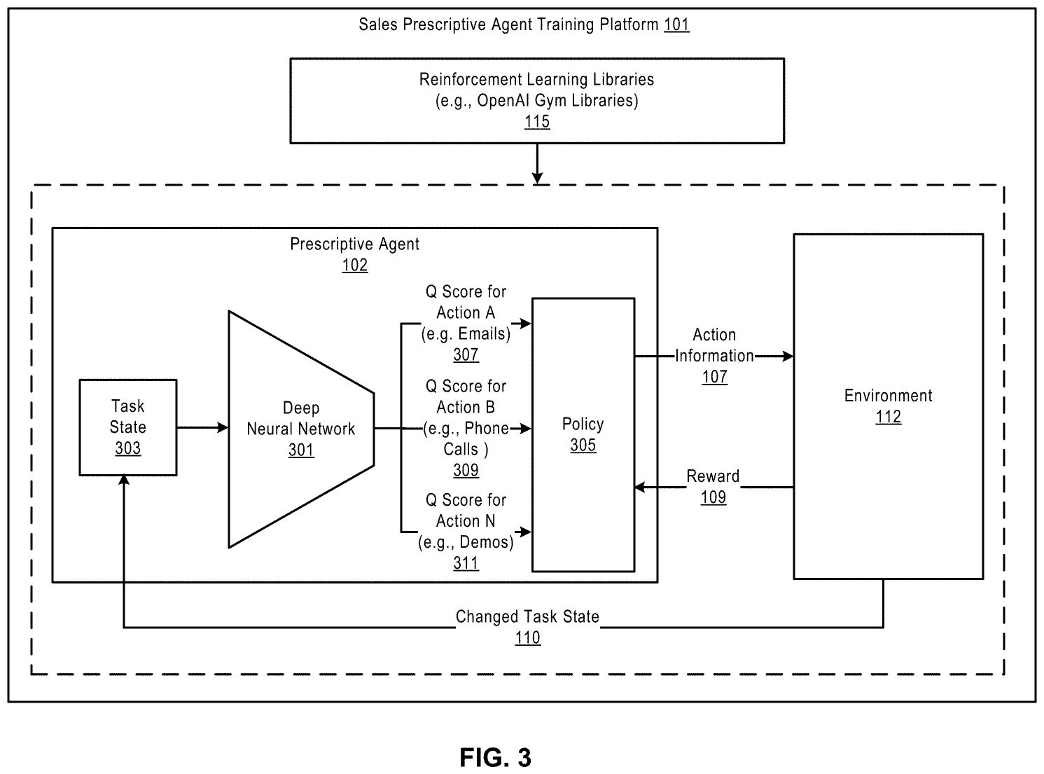

FIG. 3 further illustrates the system 100 for training an AI agent for prescribing actions for a given sales opportunity according to one embodiment, More specifically, FIG. 3 illustrates the prescriptive agent 102 in detail.

In this embodiment, the prescriptive agent 102 is implemented using a deep neural network (DNN) 301. The DNN 301 can be one of a variety of neural network models, for example, a convolutional neural network (CNN) or a LSTM model. The DNN 301 can take a task state 303 (e.g., a sales opportunity or a project) as an input and output a Q score for each pair of action and state. The action can be one of the actions as described above. The state can be any of the predetermined stages of a simulated task except the “Closed” stage and the “Abandoned” stage, since an episode of training will come to an end and the environment will return “DONE” status if the state from the prescriptive agent 102 is either “Closed” or “Abandoned”.

For the first iteration of an episode, the simulated task can be in a state represented by a “New” stage and one or more other attributes; for the next iteration, the state can be a changed task state 110 received from the environment. A state change be a change in the state of the simulated task, or a change in one or more other attributes, such as a source contact or a client/target contact.

In one embodiment, the Q score for each action-state pair represents an expected total future reward for taking a particular action given a particular state. As shown in FIG. 3, the DNN 301 can output a Q score for Action A 307, a Q score for action B 309, and a Q score for action N 311. A policy function 305 can compare the Q scores from the DNN 301 and select an action with the largest Q score for the particular state of the simulated task, and output the action and the particular state in the action information 107 to the environment 112.

In one embodiment, the policy function can receive the reward 109, which is the ground truth value for performing the action selected by the policy function 305. For the first iteration in each episode, the reward can be a random number in a predetermined range. The policy function 305 can include a loss function (e.g., a mean squared error loss function), which can use the Q score (i.e., expected reward value) for the selected action and the reward returned from the environment 112 to train the DNN 301.

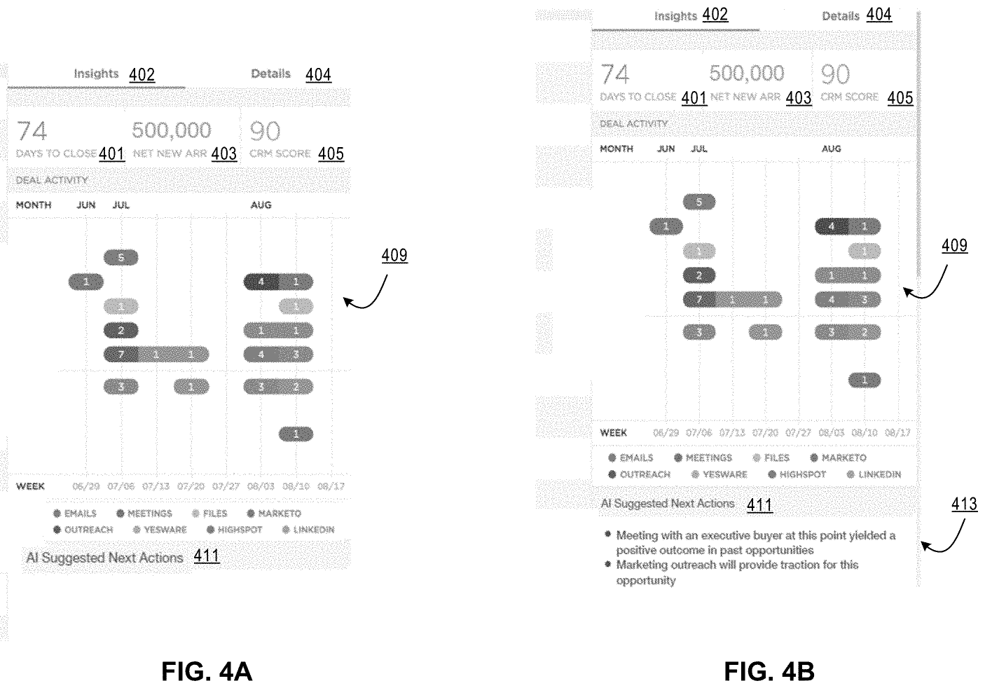

FIGS. 4A-4B illustrate a graphic user interface where a user can see the suggested actions generated by a trained AI prescriptive agent according to one embodiment.

As shown in FIG. 4A and FIG. 4B, an “insights” link 402 and an “details” link 403 on the top of the graphical user interface allow a user to switch between detailed information and suggested actions for a particular task.

When the link “Insights” is clicked, the graphical user interface can display a number of days 401 in which the given task is expected to close, a net new annual recurring revenue (ARR) 403 for the task, and a CRM score 405 for the task. Further, the graphical can display the activities 409 that have been conducted for this particular task 409. As shown, different types of activities, e.g., emails, and meetings, are displayed for the months of June, July and August.

At the bottom of the graphical user interface, an expandable section 411 can be used to retrieve the next suggested actions from the prescriptive AI agent for the give task. When a user expands the section 419 by clicking on it, as shown in FIG. 4B, suggested actions 413 for the user to take can be displayed at the bottom of the graphical user interface.

For example, the prescriptive AI agent can generate the following text in response to the user expanding the section 419: Meeting with an executive buyer at this point yielded a positive outcome in the past opportunities. Marketing outreach will provide tractions for this task.

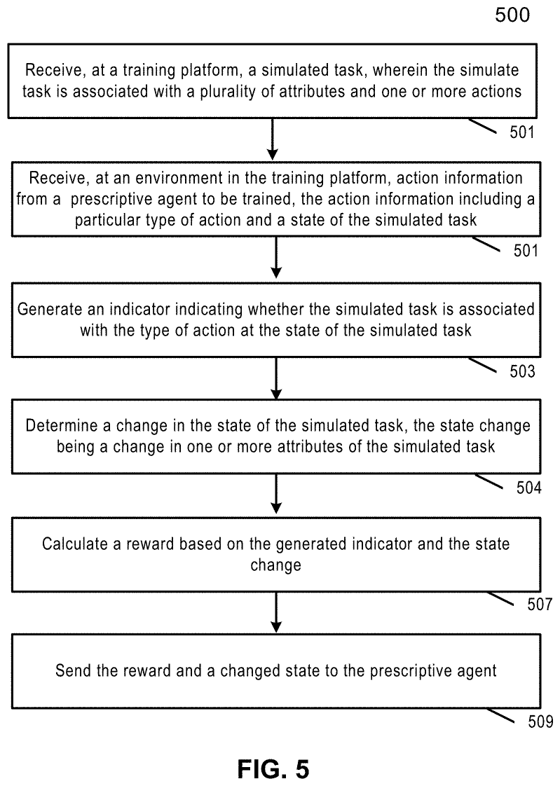

FIG. 5 illustrates a process 500 of training a prescriptive agent to prescribe actions for a task according to one embodiment. Process 500 may be performed by process logic that includes software, hardware, or a combination thereof. For example, process 400 may be performed by the prescriptive agent 102, the environment 112, and the task management module 113 in FIG. 1.

Referring to FIG. 5, in operation 501, process logic receives a simulated task, which is associated with a plurality of attributes and one or more actions. In operation 503, the process logic receives action information from a prescriptive agent to be trained, the action information including a particular type of action and a state of the simulated task. In operation 505, the process logic generates an indicator indicating whether the simulated task is associated with the type of action at the state of the simulated task. In operation 507, the process logic determines a change in the state of the simulated task, the state change being a change in one or more attributes of the simulated task. In operation 509, the process logic calculates a reward based on the generated indicator and the state change. In operation 511, the process logic sends the reward and a changed state to the prescriptive agent.

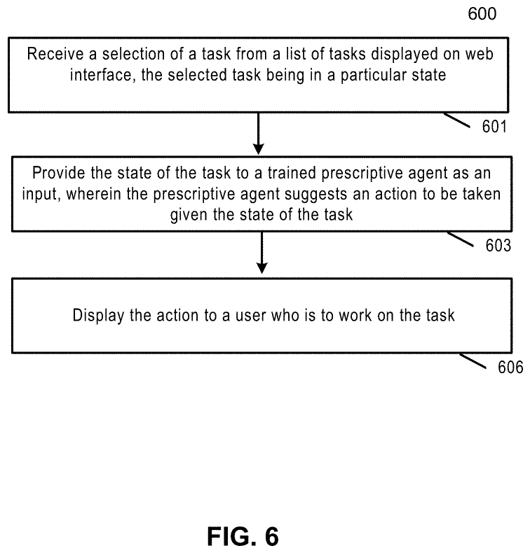

FIG. 6 illustrates a process 600 of prescribing a next action for a sales opportunity using a prescriptive agent. Process 600 may be performed by process logic that includes software, hardware, or a combination thereof. In operation 601, the process logic receives a selection of a task from a list of tasks displayed on web interface, and the selected task is in a particular state. In operation 603, the process logic provides the state of the task to a trained prescriptive agent as an input, and the prescriptive agent is running in a cloud server and suggests an action to be taken given the state of the task. In operation 605, the process logic displays the action to a user who is to work on the task.

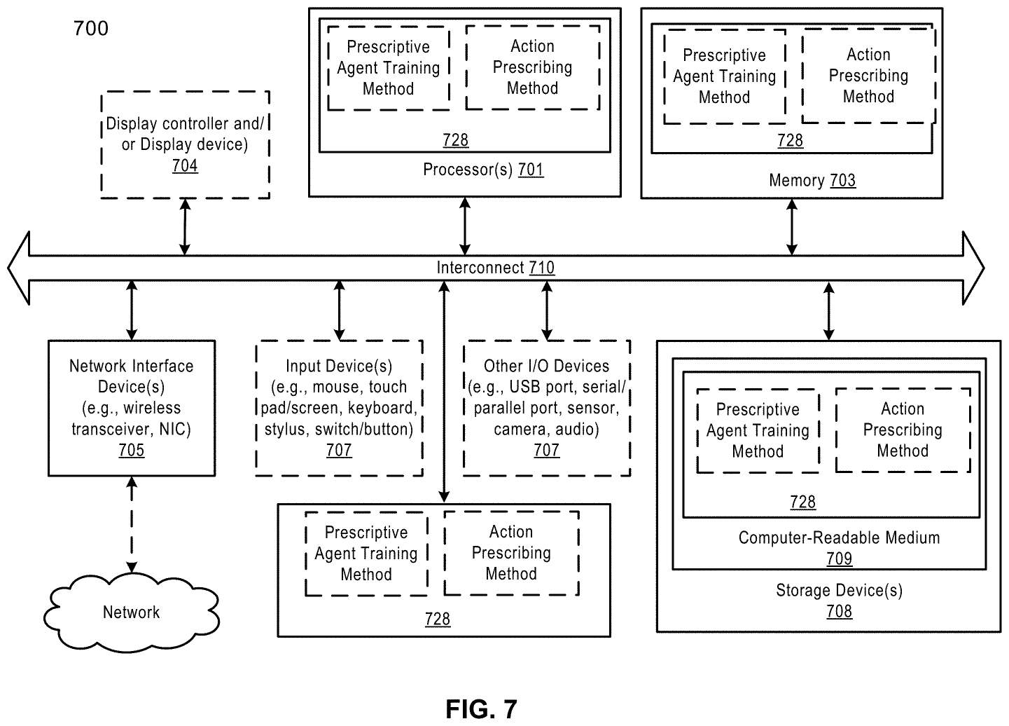

FIG. 7 is a block diagram illustrating an example of a data processing system which may be used with any embodiment of the invention. For example, system 700 may represent any of data processing systems described above performing any of the processes or methods described above. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

System 700 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

For one embodiment, system 700 includes processor 701, memory 703, and devices 705-708 via a bus or an interconnect 710. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra-low voltage processor, may act as a main processing unit and central hub for communication with the various components of the system. Such processor can be implemented as a system on chip (SoC). Processor 701 is configured to execute instructions for performing the operations and steps discussed herein. System 700 may further include a graphics interface that communicates with optional graphics subsystem 704, which may include a display controller, a graphics processor, and/or a display device.

Processor 701 may communicate with memory 703, which in one embodiment can be implemented via multiple memory devices to provide for a given amount of system memory. Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 700 may further include IO devices such as devices 705-708, including network interface device(s) 705, optional input device(s) 707, and other optional IO device(s) 707. Network interface device 705 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 707 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 707 may include an audio device. An audio device may include a speaker and/or a microphone to facilitate voice-enabled functions, such as voice recognition, voice replication, digital recording, and/or telephony functions. Other IO devices 707 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 707 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 710 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However, for other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 701, e.g., via a serial peripheral interface (SPI). This flash device may provide for non-volatile storage of system software, including a BIOS as well as other firmware of the system.

Storage device 708 may include computer-accessible storage medium 709 (also known as a machine-readable storage medium or a computer-readable medium) on which is stored one or more sets of instructions or software (e.g., module, unit, and/or logic 728) embodying any one or more of the methodologies or functions described herein. Module/unit/logic 728 may represent any of the components described above. Module/unit/logic 728 may also reside, completely or at least partially, within memory 703 and/or within processor 701 during execution thereof by data processing system 700, memory 703 and processor 701 also constituting machine-accessible storage media. Module/unit/logic 728 may further be transmitted or received over a network via network interface device 705.

Computer-readable storage medium 709 may also be used to store some software functionalities described above persistently. While computer-readable storage medium 709 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 728, components and other features described herein can be implemented as discrete hardware components or integrated in the functionality of hardware components such as ASICS, FPGAs, DSPs or similar devices. In addition, module/unit/logic 728 can be implemented as firmware or functional circuitry within hardware devices. Further, module/unit/logic 728 can be implemented in any combination hardware devices and software components.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method of training a prescriptive agent to prescribe actions for a task, comprising:
receiving, at a training platform, a simulated task, wherein the simulate task is associated with a plurality of attributes and one or more actions;
receiving, at an environment in training platform, action information from a prescriptive agent to be trained, the action information including a particular type of action and a state of the simulated task;
generating an indicator indicating whether the simulated task is associated with the type of action at the state of the simulated task;
determining a change in the state of the simulated task, the state change being a change in one or more attributes of the simulated task;
calculating a reward based on the generated indicator and the state change; and
sending the reward and the changed state to the prescriptive agent.

2. The method of claim 1, wherein the plurality of attributes of the simulated task include a stage of the simulated task, and associated source contacts and target targets of the simulated task, and wherein a stage is a phase in a life cycle of the simulated task.

3. The method of claim 1, wherein the prescriptive agent is a deep neural network, which takes a state of one of the simulated task as an input, and outputs a plurality of Q scores, each Q score representing an expected total future reward for taking one of the plurality of actions for the state.

4. The method of claim 1, wherein the prescriptive agent includes a policy function that selects an action associated with a highest Q score of the plurality of Q scores, and sends the selected action and the state of the simulated task to the environment.

5. The method of claim 4, wherein the reward is a ground truth value for the selected action, and wherein a loss function in the policy function is to use the ground truth value and the highest Q score to train the prescriptive agent.

6. The method of claim 1, wherein the plurality of actions include an email message, a phone conversation, a meeting, a document sharing, a demo, a proof of concept (POC), a business valediction, a technical validation, a contract negotiation.

7. The method of claim 1, wherein the plurality of actions further include one or more derived features, including a frequency of one of the plurality of actions, a sentiment score, and a timing of one of the plurality of actions.

8. The method of claim 1, wherein the state of the simulated task is defined by the plurality of attributes of the simulated task

9. A data processing system, comprising:
a processor; and
a memory coupled to the processor to store instructions therein for training a prescriptive agent to prescribe actions for a task, which instructions when executed by the processor, cause the processor to perform operations, the operations including
receiving, at a training platform, a simulated task, wherein the simulate task is associated with a plurality of attributes and one or more actions,
receiving, at an environment in training platform, action information from a prescriptive agent to be trained, the action information including a particular type of action and a state of the simulated task,
generating an indicator indicating whether the simulated task is associated with the type of action at the state of the simulated task,
determining a change in the state of the simulated task, the state change being a change in one or more attributes of the simulated task,
calculating a reward based on the generated indicator and the state change, and
sending the reward and the changed state to the prescriptive agent.

10. The system of claim 9, wherein the plurality of attributes of the simulated task include a stage of the simulated task, and associated source contacts and target targets of the simulated task, and wherein a stage is a phase in a life cycle of the simulated task.

11. The system of claim 9, wherein the prescriptive agent is a deep neural network, which takes a state of one of the simulated task as an input, and outputs a plurality of Q scores, each Q score representing an expected total future reward for taking one of the plurality of actions for the state.

12. The system of claim 9, wherein the prescriptive agent includes a policy function that selects an action associated with a highest Q score of the plurality of Q scores, and sends the selected action and the state of the simulated task to the environment.

13. The system of claim 12, wherein the reward is a ground truth value for the selected action, and wherein a loss function in the policy function is to use the ground truth value and the highest Q score to train the prescriptive agent.

14. The system of claim 9, wherein the plurality of actions include an email message, a phone conversation, a meeting, a document sharing, a demo, a proof of concept (POC), a business valediction, a technical validation, a contract negotiation.

15. The system of claim 9, wherein the plurality of actions further include one or more derived features, including a frequency of one of the plurality of actions, a sentiment score, and a timing of one of the plurality of actions.

16. The system of claim 9, wherein the state of the simulated task is defined by the plurality of attributes of the simulated task

17. A data processing system, comprising:
a processor; and
a memory coupled to the processor to store instructions therein for prescribing a next action for a sales opportunity using a prescriptive agent, which instructions when executed by the processor, cause the processor to perform operations, the operations including
receiving a selection of a task from a list of tasks displayed on web interface, the selected task is in a particular state,
providing the state of the task to a trained prescriptive agent as an input, wherein the prescriptive agent suggests an action to be taken given the state of the task, and
displaying the action to a user who is to work on the task.

18. The system of claim 17, wherein the prescriptive agent is a trained deep neural network (DNN) model.

19. The system of claim 17, wherein the DNN model is trained using Deep Reinforcement methodology based on time-series data of past sales opportunities.

20. The system of claim 17, wherein the action is one of a plurality of actions, including an email message, a phone conversation, a meeting, a document sharing, a demo, a proof of concept (POC), a business valediction, a technical validation, a contract negotiation.
